(19) United States
(12) Patent Application Publication
(10) Pub. No.: US 2007/0114166 A1
(43) Pub. Date: May 24, 2007

(54) DUAL ELEMENT VACUUM FILTRATION SYSTEM FOR METAL-WORKING FLUIDS

(76) Inventors: James W. Lupien, Windham, NH (US); Gregory Sorge, North Haven, CT (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/551,738

(22) Filed: Oct. 23, 2006

Related U.S. Application Data
(60) Provisional application No. 60/737,970, filed on Nov. 18, 2005.

(51) Int. Cl. B23Q 11/00; B01D 36/04

(52) U.S. Cl. 210/298

(57) ABSTRACT

A filtration system for removing solid particles from a liquid that includes a liquid-containing tank and a spaced pair of filtration elements immersed in the liquid in the tank. Each filtration element is selectively connectable to a source of vacuum to draw liquid from the tank through a spaced pair of filter screens carried by the filtration element to filter out particles from the liquid, or, alternately, to a source of pressure to backwash the filter screens to clean collected particles therefrom. By providing a pair of filtration elements, one of any such elements can be kept operating in a filtration mode while the other is operating in a backwashing mode. An endless dragout conveyor is positioned in the tank beneath the filtration elements to collect and carry out particles that fall from or between the filtration units to an elevated external deposit location. Each filtration element has at least one filter screen, and preferably two or more spaced pairs of filtration screens.

### CROSS REFERENCE TO RELATED APPLICATION

This application is based on co-pending provisional patent application No. 60/737,970, which was filed on Nov. 18, 2005.

### FIELD OF THE INVENTION

This invention relates to a vacuum filtration system for filtering solid particles, such as metal particles, from a circulating fluid stream, such as a cooling or lubricating liquid of a type used in a metal-working installation.

### BACKGROUND OF TEE INVENTION

U.S. Pat. No. 5,221,469 (Nehls) describes a vacuum filtration system that is used in filtering metal particles from a circulating liquid in a metal-working installation. The system of this reference uses a single star-shaped vacuumized filter that is immersed in a tank of metal-working liquid, with an arrangement for periodically pressurizing the filter to remove metallic particles that may have accumulated on the filter element. Of course, during the backwashing of the filter, no removal of other particles in the liquid can occur.

### SUMMARY OF THE INVENTION

According to the present invention there is provided a vacuum filtration system with two or more filter units for removal of particles, such as metallic particles in a stream of a metal-working liquid or solid particles in a stream of waste water. The filter units are intermittently individually purged or backwashed to remove accumulated particles from each filter such that one or more of the filter units is always operating in a filtration mode, even if another filter unit is being backwashed. The filtration units of the present invention are immersed in a tank that holds the fluid being treated, and a piping system, with appropriately-controlled valves, is provided to selectively impose a vacuum on each filter unit, or introduce a pressurized medium into each filter unit to backwash accumulated particles from the filter face of a filter element in the filter unit. In this manner, all filter elements can be kept appropriately clean for suitable filtering action without the need to totally interrupt the filtering action of the system for backwashing of any filter element. Preferably, each filter unit includes a spaced-apart pair of filter elements that are simultaneously vacuumized or pressurized as the case may be.

### BRIEF DESCRIPTION OF THE DRAWING

FIG. 1 is a plan view of an embodiment of a dual filter unit vacuum filtration system for metal-working fluids according to an embodiment of the present invention;

FIG. 2 is an elevation view, partly in cross-section, of the vacuum filtration system of FIG. 1;

FIG. 3 is a side elevation view of the vacuum filtration system of FIGS. 1 and 2;

FIG. 4 is an elevation view, partly in cross-section, of one of the filter elements of the embodiment of FIGS. 1-3;

FIG. 5 is a plan view of the filter element of FIG. 4;

FIG. 6 is an end view of the filter element of FIGS. 4 and 5;

FIG. 7 is a view like FIG. 6 of the filter unit of FIGS. 4 and 5 showing various directions of flow during the pressurized backwashing;

FIG. 8 is an exploded, perspective view of a filter element according to an alternative embodiment of the present invention;

FIGS. 9-11 are fragmentary views, each at an enlarged scale, of components of the filter element of FIG. 8;

FIG. 12 is a view like FIG. 1 of an alternative embodiment of the present invention; and

FIG. 13 is a view like FIG. 2 of the embodiment of FIG. 12.

### DETAILED DESCRIPTION OF THE INVENTION

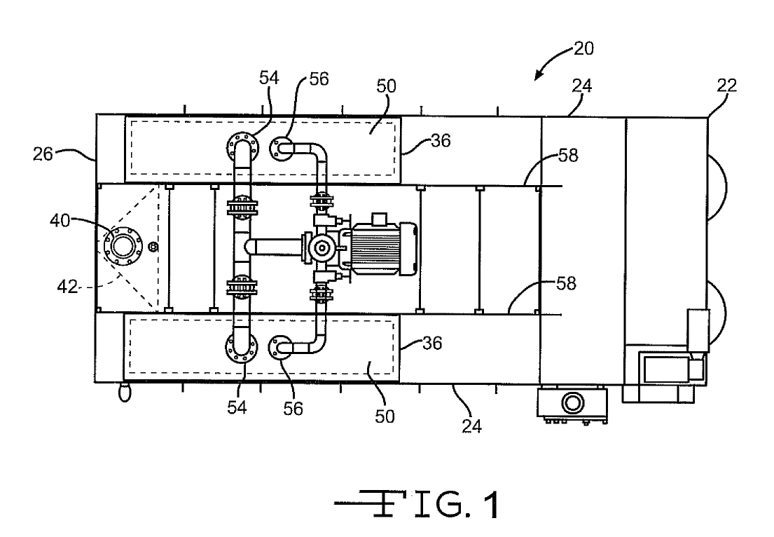

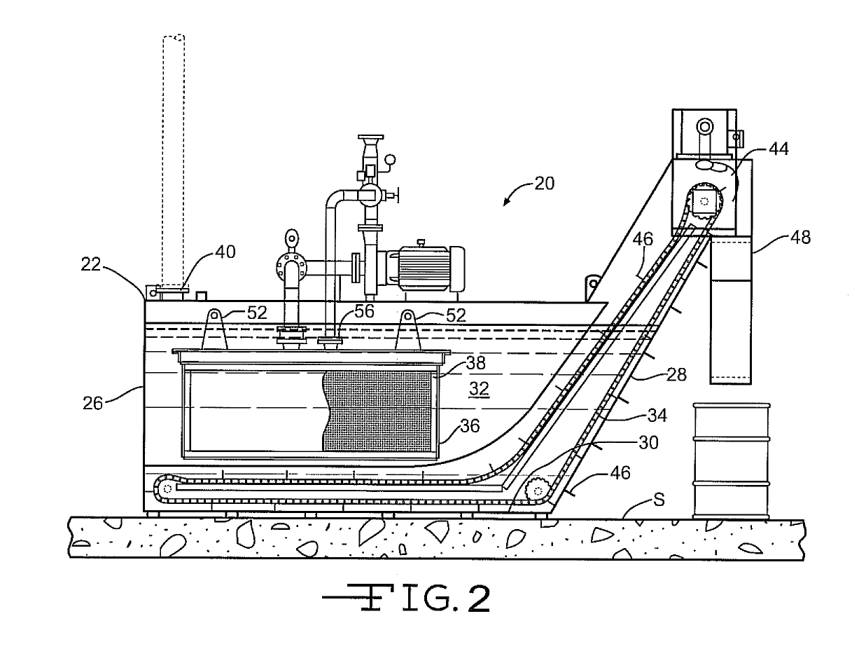

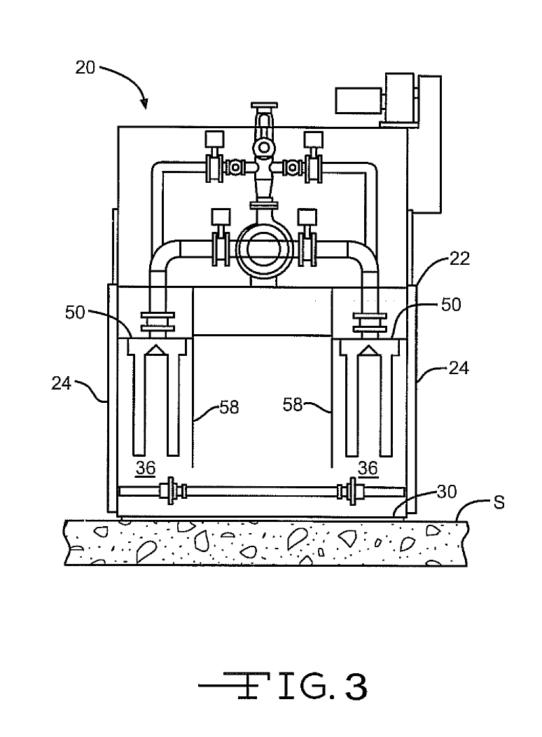

An embodiment of the filtration system according to the present invention is identified generally by reference numeral 20 in FIGS. 1-3. The filtration system 20 includes an open top liquid-holding tank 22. The tank 22 is defined by a spaced plurality of sidewalls 24, a vertical end wall 26, and an opposed, obliquely-extending end wall 28, which extends, for example, at an angle of 60° to a support surface S, and a bottom wall 30. The tank 22 has a central, liquid-containing compartment 32 for settling of heavy solids from a liquid in the tank 22, which also serves to provide a free-flowing skimming path for floating swarf and tramp oil to reach an endless dragout conveyor 34. The tank 22 further has a spaced plurality, for example, two, filtration compartments or units 36, each of which contains a dual element filter element 38.

Contaminated or dirty liquid to be filtered is introduced into the tank 22 from an overhead downward pipe 40 into a tapered entry chute 42, which is flared outwardly toward the full width of the settling compartment 32 and is positioned at a height so that the incoming liquid enters the tank just above the levels of the filtration compartments 36, thus skimming the surface of the liquid in the tank longitudinally within the tank 22 as it flows to the end wall 28.

The dragout conveyor 34 extends substantially across the full width of the tank 22 and is positioned below the levels of the filtration compartments 36 and is powered by a gear reducer and roller chain drive 44 to slowly intermittently or continuously advance spaced angle irons or other raised flights 46 on the dragout conveyor 34 to advance the debris from the bottom wall 30 or settling from the central compartment 32 to a discharge chute 48 for discharging to a container. Subsequently, the flights 46 are scraped clean before reimmersion in the tank 22. The flights 46 travel from the filtration system 20 across the tank 22 by way of a path that has a first, horizontally extending travel path and then through an obliquely-extending travel path to discharge accumulated debris at an elevated location into a discharge chute 48, and the flights 46 return into the liquid supported by return angles that are preferably capped with wear pads, for example, ½ inch thick polyurethane wear pads. When the dragout conveyor 34 is driven in an indexing manner, the gear reducer drive 44 is controlled to provide for variable dwell periods between advance motions to ensure that liquid advanced by the dragout conveyor 34 toward the discharge chute 48 can drain back into the tank 22 before the accumulated debris can drain back into the tank 22. While a single width dragout conveyor 34 will normally be used, it is also contemplated that multiple, side-by-side partial width dragout conveyors can advantageously be used in very large systems, or in systems that operate under heavy loads, for example, a separate conveyor under each of the compartments 32 and 36.

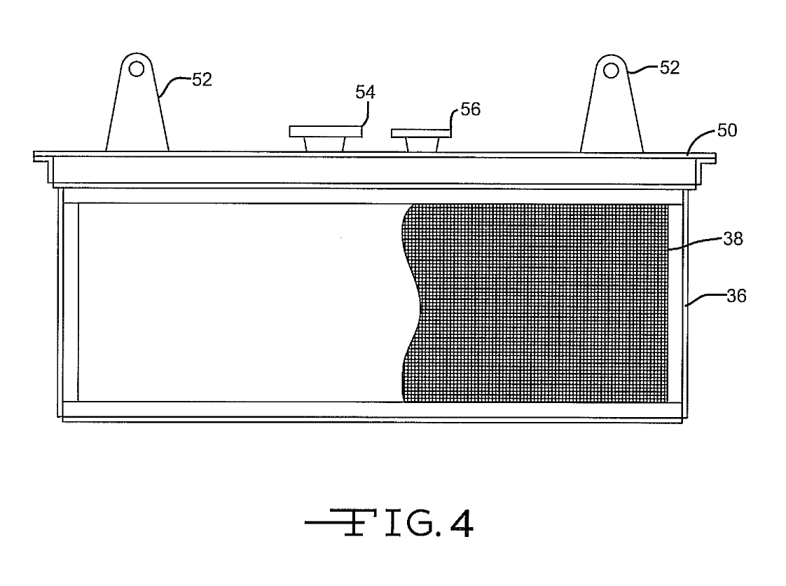

As shown in FIGS. 4 and 5, each of the filtration elements 36 contains a filtration element 38 of equal size and filtration surface area. Each filtration element 36 is sized to provide the maximum flow rate of the filter when operating alone, and each has a removable top plate 50 and a spaced plurality of lifting eyes 52, which are vertically tapered toward suction 54 and pressurized backwash 56 flanges. A removable vertical divider or baffle 58 is also provided to isolate each filtration unit 36 for internal cleaning and to ensure that the liquid being filtered flows upwardly past the filtration unit 36.

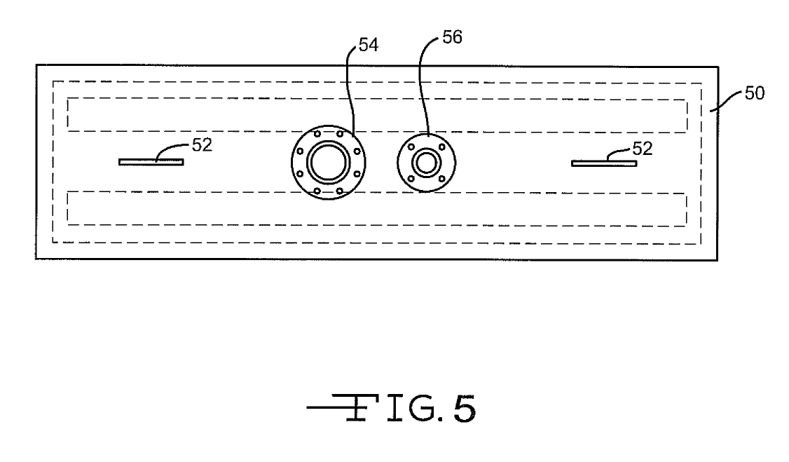

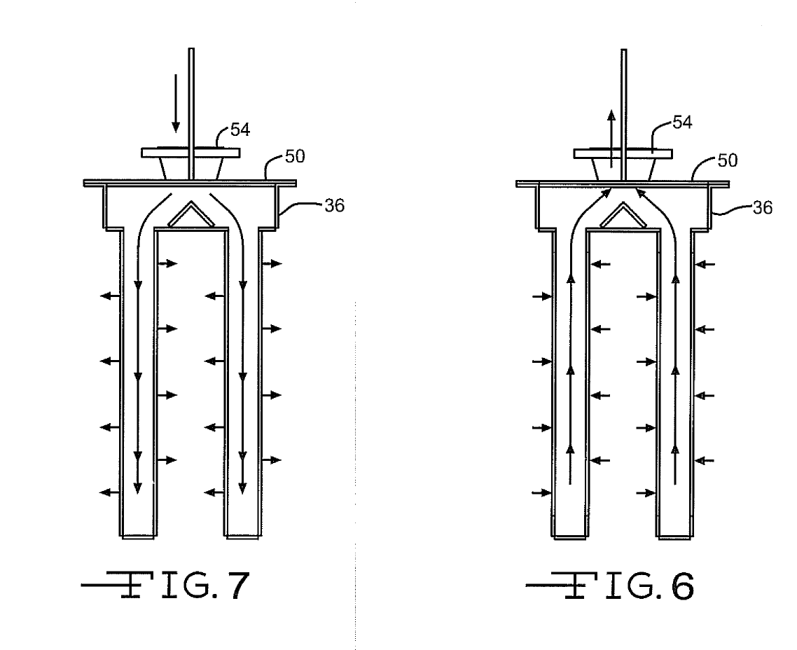

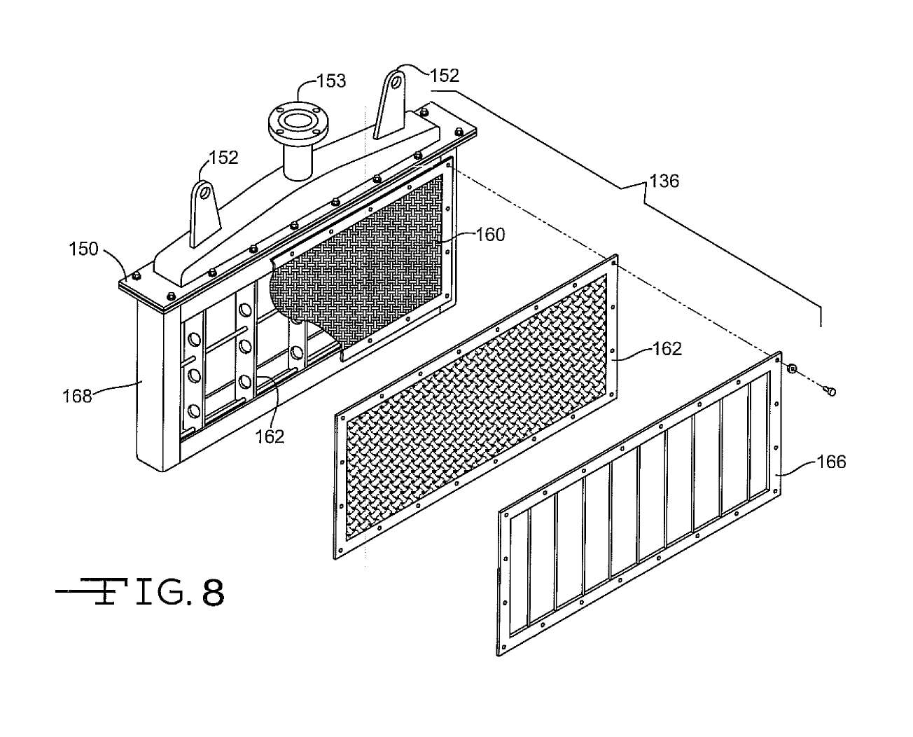

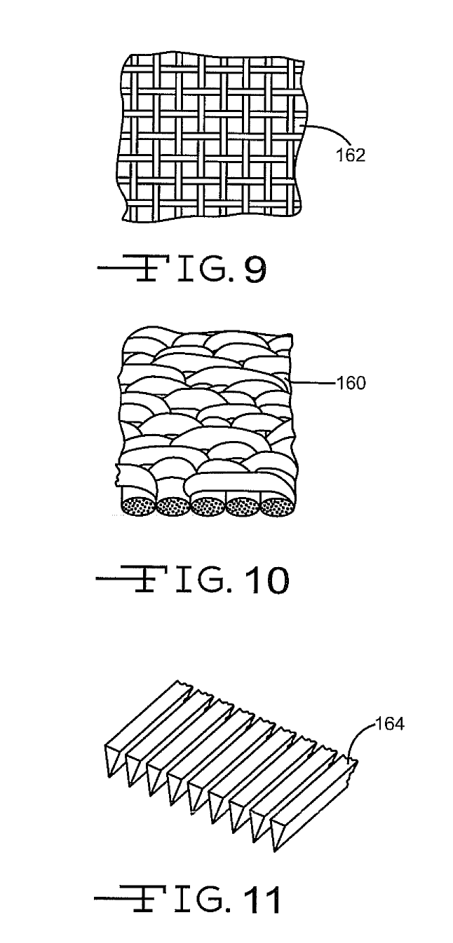

In the embodiment of FIGS. 8-13, elements that correspond in construction or function to the elements of the embodiment of FIGS. 1-7 are identified by a three-digit reference numeral, the last two digits of which correspond to the two digits of the embodiment of FIGS. 1-7.

FIG. 8 illustrates a filtration element 136 in which a tapered top plate 150 is provided with a spaced pair of lifting eyes 152 and a flange 153 that serves as a connection to combined suction and backwash lines. The filtration element 136 has a filtration screen 162, and preferably a spaced pair of like filtration screens mounted in a like manner, each of which, preferably, is a double layer weave synthetic fabric with a factory heat sealed edge. The filtration element 136 further has an internal backing 160 for each filtration screen 162 that is a rigid sheet of stainless steel wire cloth with a usable open area of at least 90% to support the filtration screen 162 during vacuum operation, and a bar screen or grid 166 is provided on the exterior of each filtration element 160 to support the filtration element during backwashing.

For rigidity in service, both in vacuum operation and in backwashing operation, the filter screen 162, the backing 160 and the grid 166 are bolted to a peripheral frame 168 that depends from the top plate 150.

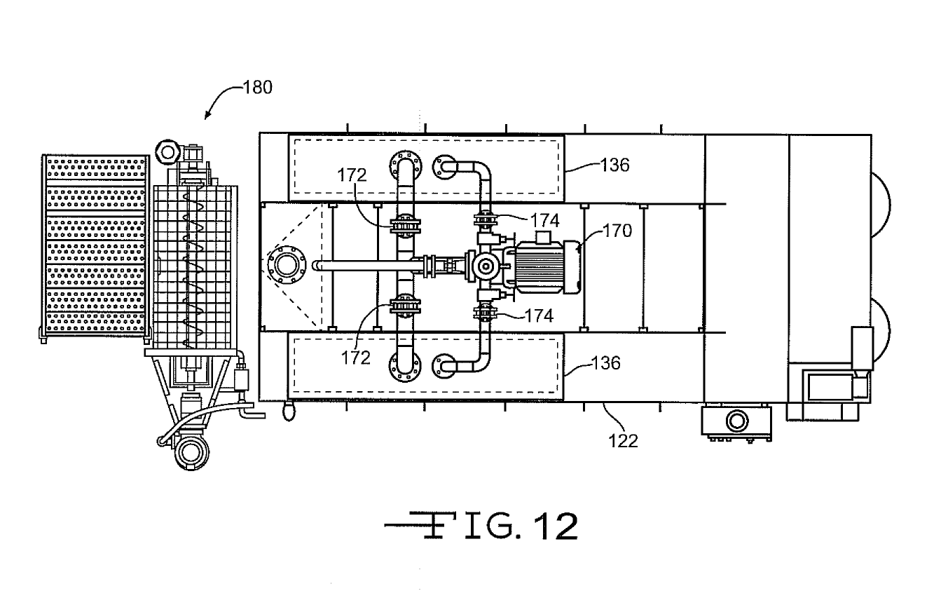

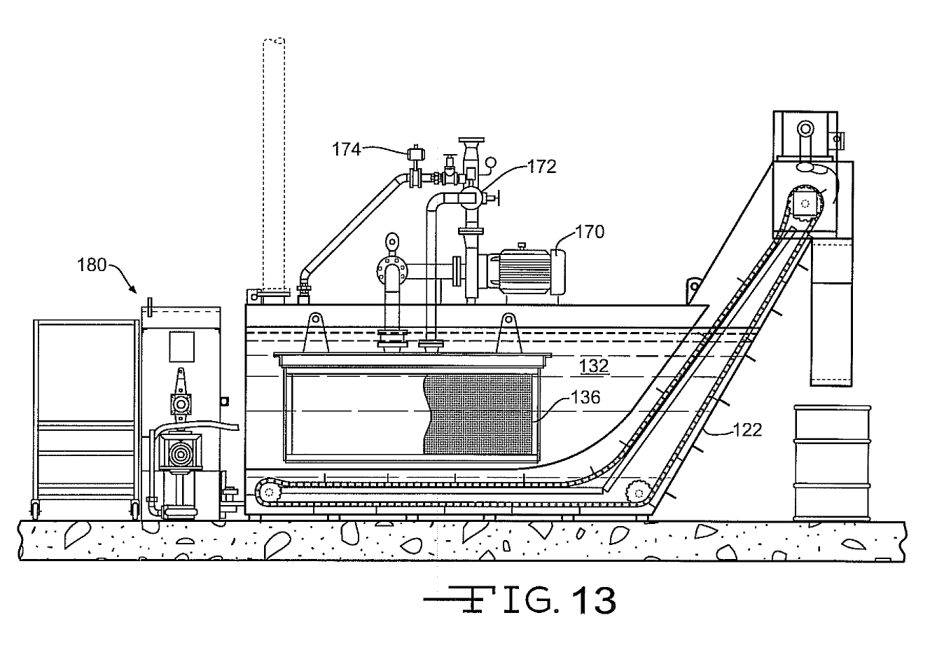

In the embodiment of FIGS. 12 and 13, a vacuum/backwash pump 170 normally draws contaminated coolant or other liquid through one or both of the filtration units 136, and filtered liquid is pumped to an associated station, such as a machine tool (not shown) by the pump 170. When a unit 136 becomes loaded with solids, for example, as detected by a pressure/vacuum switch, a backwash cycle is begun as to the contaminated unit by closing a suction valve 174 and opening a backwash valve 172 by automated pneumatic operators. Preferably, in a dual filter element installation, only one filtration element 136 is in vacuum operation at any time, so that operation in a backwashing mode can proceed in the other element 136. To maintain constant pressure in the elements 136, the motor of the pump is of a variable frequency drive type.

For optimum filtration of the liquid entering into a tank 122 for the embodiment of FIGS. 12 and 13, optionally there may be provided an automated cellulose feeder, which is generally identified by reference numeral 180, to introduce a cellulose slurry onto each of the filtration elements 136. When using a cellulose feeder 180, each of the suction valves 174 is open and a bypass valve opens to increase the flow as the cellulose feeder feeds cellulose. The cellulose will precoat each filtration screen 162 of each of the filtration elements 136 to aid in the removal of very fine solids from the coolant or other liquid being treated. Further, skimming in an entry settling compartment forces separated lubricant or hydraulic tramp oil to the ramp end of the filtration tank into two separated oil collection areas for removal by two optional belt type oil skimmers.

Thus, there is disclosed an efficient and effective two stage filtration system, with a unique, dual element module filter design that provides two times the filtration area and further provides precisely-sealed filter screens that have two times the open area, with valving for automated on-line and off-line operation, and a simplicity of operation with a high level of automation to provide unmatched filtration performance when compared to conventional vacuum filters. In the present invention, the separate filtration units are located in separate and isolated chambers, thus providing unobstructed settling in a primary settling chamber therebetween and providing a tranquil area for filtration of the fines that remain in suspension. Since each of the filtration units is occasionally pressure backwashed by the filter/system pump, and because one filtration unit is always on line, there is no need for a separate clean/regeneration tank. Therefore, there is no wasted fluid to maintain in an overflowing clean tank or replenish tank after regeneration. This also eliminates the extra turbulence in the settling tank created by the overflowing clean tank. In many prior art cases, a regeneration cleaning tank is elevated over the cleaning tank, and therefore the dirty tank must be designed to hold all of the fluid resulting in unnecessarily large dirty tanks with unusable capacity.

The filtration system of the present invention can have one or more vertical arms extending down into the liquid, two such arms in the illustrated embodiments. Each arm has two separated opposed filtering surfaces and is connected to an upper suction and backwash connection. Each filtration element is positioned on opposite sides of the main settling chamber and parallel with the tank wall, thus providing a large amount of filtration area in a small footprint.

The removable suction screen elements are designed for ease of manufacturing, installation and maintenance and combine simplicity with efficiency and affordability. The element framework may be constructed of mild steel and the filter screen may be constructed of 0.015 inch gap stainless steel wedge wire. The wedge wire slots are positioned in the vertical direction, enhancing cake release. Each of the two suction screen elements may have a flanged top suction connection with an in-line check valve to keep the filter pump primed and a separate flanged top backwash connection. These elements are designed to simply hang in the liquid, supported by angle iron ledges off the tank wall, eliminating gaskets, O-rings or wet seals required in other designs. The top, flanged connections for the suction and backwash are above the liquid level providing easy access without entering or draining the tank. Each element has a bolt-on cover and removable vertical divider rack to allow for internal cleaning.

The filtration units of the present invention require no moving belt, no brushing, are easy to inspect, do not require a separate regeneration tank, are positively sealed, are not subject to misting, are easy to replace, and are readily controlled by a variable frequency drive for constant output pressure. By spacing the separate filtration units from one another, effective gravity settling of heavy solids in the liquid being cleaned can occur therebetween, to eliminate the accumulation of such heavy solids on the filtration surfaces of the filtration units. Because there is no need to deflect incoming flow across the filtration surface of each filtration element, incoming liquid flow can be immediately directed forward across the surface of the fluid, which creates the desired effect of moving floating swarf and tramp oil to the discharge station.

Although the best mode contemplated by the inventors for carrying out the present invention as of the filing date hereof has been shown and described herein, it should be apparent to those skilled in the art that suitable modifications, variations and equivalents may be made without departing from the scope of the invention, such scope being limited only by the terms of the following claims and the legal equivalents thereof.

1. A backwashable vacuum filtration element for filtering solids from a liquid, said filtration unit comprising, in combination:
a frame having a fluid connection for imposing a vacuum on an interior of the frame;
a spaced pair of flexible filtration screens carried by the frame to be acted on by the vacuum;
a relatively inflexible screen on an interior of each filtration screen to prevent the filtration element from deflecting inwardly under vacuum; and
a grid on an exterior of each filtration screen to prevent the filtration screen from deflecting outwardly under backwashing pressure;
each of the relatively inflexible screen and grid being substantially more open to flow than each filtration screen.

2. A filtration element according to claim 1 wherein:
each filtration element comprises a double layer weave synthetic fabric panel; and
each relatively inflexible screen is a metallic plain weave wire cloth with a usable open area of at least 90%.

3. A filtration element according to claim 2 wherein each relatively inflexible screen comprises a stainless steel wire cloth.

4. A dual element backwashable vacuum filtration system for filtering solids from a liquid, said filtration system comprising, in combination:
a tank adapted to contain a liquid;
first and second spaced filtration elements adapted to be positioned in a liquid in the tank, each filtration element comprising:
a frame having a fluid connection for imposing a vacuum on an interior of the frame;
a spaced pair of flexible filtration screens carried by the frame to be acted on by the vacuum;
a relatively inflexible screen on an interior of each filtration screen to prevent the filtration screen from deflecting inwardly under vacuum; and
a grid on an exterior of each filtration screen to prevent the filtration screen from deflecting outwardly under backwashing pressure;
each of the relatively inflexible screen and grid being substantially more open to flow than each filtration screen.

5. A filtration system according to claim 4 wherein:
each filtration screen is a double layer weave synthetic fabric panel; and
each relatively inflexible screen is a metallic plain weave wire cloth with a usable open area of at least 90%.

6. A filtration system according to claim 5 wherein:
each relatively inflexible screen comprises a stainless steel wire cloth.

7. A filtration system according to claim 4 and further comprising:
means for selectively imposing either a vacuum or a backwashing pressure on each filtration unit.

8. A filtration system according to claim 4 and further comprising:
first and second spaced baffles dividing the tank into a settling compartment between said first and second filtration elements.

9. A filtration system according to claim 8 and further comprising:
an endless dragout conveyor having a first portion underlying said first and second spaced baffles for collecting settled solids from said tank and a second portion extending beyond said tank for discharging the settled solids at an elevated location external to said tank.

10. A filtration system according to claim 9 and further comprising:
a spaced plurality of raised flights on said conveyor for advancing settled solids on said conveyor with said conveyor.

11. A filtration system according to claim 4 and further comprising:
separate vacuum and pressurizing connections on each of said filtration elements for alternately imposing a vacuum or a backwash pressure connection on each of said first and second filtration units.

12. A filtration system according to claim 9 and further comprising:
a combined vacuum and pressure connection on each of said filtration elements for alternately imposing a vacuum or a pressure connection on each of said filtration elements.

13. A filtration system according to claim 12 and further comprising:
a pressure/vacuum-controlled variable frequency drive motor for controlling the imposition of vacuum and pressure on each of said filtration elements to maintain a constant output pressure on each of said filtration elements during the imposition of vacuum or pressure thereon.

14. A filtration system according to claim 9 wherein:
said tank has an inlet end, said inlet end being positioned away from said second portion of said endless conveyor and being adapted to receive liquid to be filtered, said inlet diverging outwardly as it proceeds toward said second portion of said endless conveyor.

15. A filtration system according to claim 4 wherein:
said second portion of said endless conveyor extends at an angle of approximately 60° relative to a surface on which said tank is adapted to be supported.

16. A filtration system according to claim 4 and further comprising:
a cellulose feeder for feeding a cellulose slurry into said tank to help to coat each of said filtration screens of each of said filtration elements to aid in removal of very fine solids from a liquid being treated in said tank.
